(19) United States
(12) Patent Application Publication
(10) Pub. No.: US 2023/0186943 A1
(43) Pub. Date: Jun. 15, 2023

(54) VOICE ACTIVITY DETECTION METHOD AND APPARATUS, AND STORAGE MEDIUM

(71) Applicant: Beijing Baidu Netcom Science Technology Co., Ltd., Beijing (CN)

(72) Inventors: Guochang ZHANG, Beijing (CN); Libiao YU, Beijing (CN); Jianqiang WEI, Beijing (CN)

(21) Appl. No.: 17/893,895

(22) Filed: Aug. 23, 2022

(30) Foreign Application Priority Data
Dec. 15, 2021 (CN) 202111535021.X

(51) Int. Cl. G10L 25/78; G10L 25/93

(52) U.S. Cl. CPC G10L 25/78; G10L 25/93; G10L 2025/937

(57) ABSTRACT

Provided are a voice activity detection method and apparatus, an electronic device and a storage medium, which relate to the technical field of voice processing, for example, to the technical field of artificial intelligence and deep learning. The specific implementation solution is described below. A first audio signal is acquired, and a frequency domain feature of the first audio signal is extracted; and the frequency domain feature of the first audio signal is input into a voice activity detection model, and a voice presence detection result output by the voice activity detection model is obtained, where the voice activity detection model is configured to detect whether voice is present in the first audio signal.

### CROSS-REFERENCE TO RELATED APPLICATION

This application claims priority to Chinese Patent Application No. CN202111535021.X, filed on Dec. 15, 2021, the disclosure of which is incorporated herein by reference in its entirety.

### TECHNICAL FIELD

The present disclosure relates to the technical field of voice processing, for example, to the technical field of artificial intelligence and deep learning and, in particular, to a voice activity detection method and apparatus, an electronic device and a storage medium.

### BACKGROUND

Voice activity detection (VAD) is a technology for detecting the presence or absence of speech, and is widely used in tasks such as speech coding and decoding, speech enhancement and speech recognition.

In a Voice over Internet Protocol (VoIP) communication scene, VAD can help the communication system to transmit only voice segments to reduce the transmission bandwidth. In a speech recognition scene, VAD can enable the recognition system to call the recognition engine only when voice is present, so as to reduce the calculation load of the recognition system; in the speech enhancement field, VAD can be used to assist in estimating the noise power spectrum to enhance the speech enhancement effect. In addition, VAD can be applied in scenes of automatic gain control and speaker instructing.

### SUMMARY

The present disclosure provides a voice activity detection method and apparatus, an electronic device and a storage medium.

According to an aspect of the present disclosure, a voice activity detection method is provided. The method includes steps described below.

A first audio signal is acquired, and extracting a frequency domain feature of the first audio signal is extracted.

The frequency domain feature of the first audio signal is input into a voice activity detection model, and a voice presence detection result output by the voice activity detection model is obtained, where the voice activity detection model is configured to detect whether voice is present in the first audio signal.

According to an aspect of the present disclosure, a voice activity detection apparatus is provided. The apparatus includes an audio signal processing module and a signal voice recognition module.

The audio signal processing module is configured to acquire a first audio signal, and extract a frequency domain feature of the first audio signal.

The signal voice recognition module is configured to input the frequency domain feature of the first audio signal into a voice activity detection model, and obtain a voice presence detection result output by the voice activity detection model, where the voice activity detection model is configured to detect whether voice is present in the first audio signal.

According to another aspect of the present disclosure, an electronic device is provided. The electronic device includes at least one processor and a memory communicatively connected to the at least one processor.

The memory stores instructions executable by the at least one processor. The instructions are executed by the at least one processor to cause the at least one processor to execute the voice activity detection method according to any embodiment of the present disclosure

According to another aspect of the present disclosure, a non-transitory computer-readable storage medium is provided. The storage medium stores computer instructions for causing a computer to execute the voice activity detection method according to any embodiment of the present disclosure.

According to another aspect of the present disclosure, a computer program product is provided. The computer program product includes a computer program which, when executed by a processor, implements the voice activity detection method according to any embodiment of the present disclosure.

According to embodiments of the present disclosure, the detection accuracy of voice activity detection can be improved, and the detection complexity can be reduced.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a schematic diagram of a voice activity detection method according to an embodiment of the present disclosure;

FIG. 2 is a schematic diagram of a voice activity detection method according to an embodiment of the present disclosure;

FIG. 3 is a schematic diagram of a voice activity detection method according to an embodiment of the present disclosure;

FIG. 4 is a schematic diagram of a voice activity detection method according to an embodiment of the present disclosure;

FIG. 5 is a diagram showing an application scene of a voice activity detection method according to an embodiment of the present disclosure;

FIG. 6 is a scene graph of a voice activity detection method according to an embodiment of the present disclosure;

FIG. 7 is a schematic diagram of an input audio signal according to an embodiment of the present disclosure;

FIG. 8 is a schematic diagram of an original first audio signal according to an embodiment of the present disclosure;

FIG. 9 is a schematic diagram of a first audio signal after interference removal according to an embodiment of the present disclosure;

FIG. 10 is a schematic diagram of a voice activity detection result according to an embodiment of the present disclosure;

FIG. 11 is a schematic diagram of an amplitude spectrum of an original first audio signal according to an embodiment of the present disclosure;

FIG. 12 is a schematic diagram of an amplitude spectrum of a first audio signal after interference removal according to an embodiment of the present disclosure;

FIG. 13 is a schematic diagram of a voice activity detection apparatus according to an embodiment of the present disclosure; and

FIG. 14 is a block diagram of an electronic device for implementing a voice activity detection method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

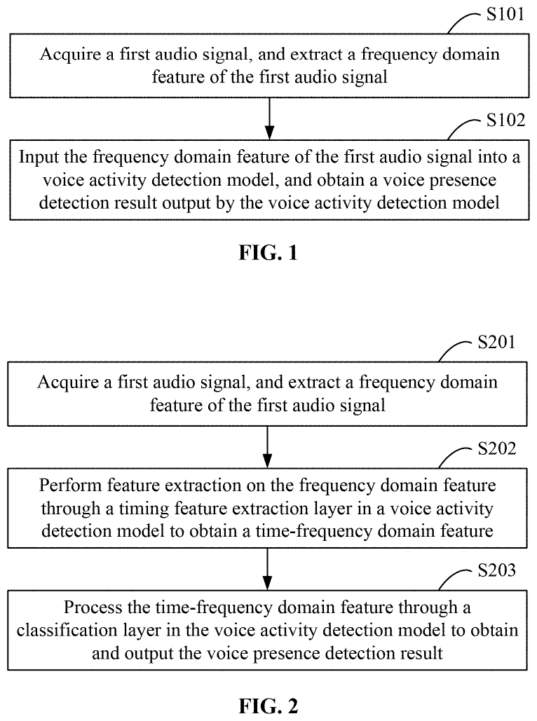

FIG. 1 is a flowchart of a voice activity detection method disclosed according to an embodiment of the present disclosure. The embodiment is applicable to a case of detecting whether voice is present in an audio signal. The method of the embodiment may be executed by a voice activity detection apparatus. The apparatus may be implemented by software and/or hardware and is specifically configured in an electronic device having a certain data computing capability. The electronic device may be a client device or a server device. The client device is, for example, a mobile phone, a tablet computer, an in-vehicle terminal, or a desktop computer.

In S101, a first audio signal is acquired, and a frequency domain feature of the first audio signal is extracted.

The first audio signal is an audio signal collected from a scene environment. Exemplarily, the application scene is a telephone communication scene, and the first audio signal is an audio signal collected from a speaker based on a microphone. The first audio signal is taken as a to-be-detected signal, and voice activity detection is performed to detect whether voice is present in the first audio signal. The frequency domain feature may refer to feature information of the first audio signal on the frequency domain. The frequency domain feature is used for detecting whether voice is present in the first audio signal. Exemplarily, the frequency domain feature may include features such as a fundamental tone, a harmonic, a linear prediction coefficient, an autocorrelation coefficient, a short-term zero-crossing rate, a long-term zero-crossing rate, short-term energy, amplitude and a phase.

In S102, the frequency domain feature of the first audio signal is input into a voice activity detection model, and a voice presence detection result output by the voice activity detection model is obtained, where the voice activity detection model is configured to detect whether voice is present in the first audio signal.

The voice activity detection model is configured to detect whether voice is present in the first audio signal based on the frequency domain feature of the first audio signal. The voice activity detection model may be a machine learning model, for example, may be a deep learning model, such as a convolutional neural network model, a Long Short-Term Memory Network (LSTM), a Temporal Convolutional Network (TCN) or a gated recurrent unit (GRU), etc. The voice presence detection result is used for determining whether voice is present in the first audio signal. For example, the voice presence detection result may be that a time period in which voice is present and/or a time period in which voice is absent are recognized in the first audio signal. Alternatively, the voice presence detection result may be that voice is present in the first audio signal, or voice is absent in the first audio signal.

One of the related voice activity detection technologies is a method based on signal processing. This method generally needs to extract some features such as a fundamental tone, a harmonic and short-term energy, and then set a determination rule and a threshold, so as to obtain the detection result that whether voice is present. Another one of the related voice activity detection technologies is a method based on deep learning and generally directly uses a recurrent neural network (RNN) to complete the mapping from features to voice presence probabilities.

The method based on signal processing is a rule-driven algorithm, and how to select features and thresholds requires a lot of experience; and this method generally can cover only part of scenes, and has relatively poor detection accuracy in some scenes. Moreover, feature extraction is performed on the input voice and noise waveforms through a Gaussian mixture model, that is, actually, Gaussian mixture assumption is performed on the distribution of the voice and the noises; in this manner, prior probability parameters are too few, and the timing relationship between the former frame and the latter frame of the voice is not taken into consideration for the model, so that the modeling capability of the model is ordinary, and high accuracy cannot be achieved. For the end-to-end deep learning model, the input is the audio signal, and the output is the detection result that whether voice is present. However, this method based on deep learning requires relatively high calculation complexity, thus posing high requirements to the running hardware devices.

According to the technical solutions of the present disclosure, the frequency domain feature of the first audio signal is extracted, the frequency domain feature is input into the voice activity detection model for processing, and the voice presence detection result is obtained. In this manner, the frequency domain feature of the first audio signal is effectively extracted, the feature extraction operations by the voice activity detection model are reduced, so that the calculation complexity of the voice activity detection model is reduced, the detection complexity of voice activity detection is reduced, and lightweight voice activity detection is achieved. Moreover, the detection efficiency of voice activity detection is improved, the feature representing the audio signal is accurately extracted, so that the representativeness of the frequency domain feature is improved, and the detection accuracy of voice activity detection is improved.

FIG. 2 is a flowchart of another voice activity detection method according to an embodiment of the present disclosure. The method is further optimized and extended based on the preceding technical solutions and may be combined with the preceding various optional embodiments. The step in which the frequency domain feature of the first audio signal is input into the voice activity detection model, and the voice presence detection result output by the voice activity detection model is obtained is specified below. Feature extraction is performed on the frequency domain feature through a timing feature extraction layer in the voice activity detection model to obtain a time-frequency domain feature, where the timing feature extraction layer is configured to perform time domain feature extraction on the frequency domain feature; and the time-frequency domain feature is processed through a classification layer in the voice activity detection model to obtain and output the voice presence detection result.

In S201, a first audio signal is acquired, and a frequency domain feature of the first audio signal is extracted.

In S202, feature extraction is performed on the frequency domain feature through a timing feature extraction layer in a voice activity detection model to obtain a time-frequency domain feature, where the timing feature extraction layer is configured to perform time domain feature extraction on the frequency domain feature.

The time-frequency domain feature may refer to a feature characterizing the first audio signal in the frequency domain and in the time domain, and is used for detecting whether voice is present in the first audio signal. The timing feature extraction layer is used for extracting a feature representing a temporal relationship based the frequency domain feature to form the time-frequency domain feature. The timing feature extraction layer is used for representing the relationship between input data and historically-input data, and may refer to a timing prediction model having a multi-layer structure. The timing prediction model may include an LSTM, a TCN, or a GRU, etc. Framing may be pre-performed on the first audio signal to achieve division of the first audio signal temporally; a frequency domain feature is extracted from each signal segment; the frequency domain feature of the each signal segment is input into the timing feature extraction layer; since the timing feature extraction layer can extract relationships between signal segments representing different times, a time domain feature can be extracted from the frequency domain feature corresponding to the each signal segment to form a time-frequency domain feature corresponding to the each signal segment. In this manner, the capability of the timing feature extraction layer to learn time-continuous voice features is improved, thus the time-frequency domain feature can better characterize the difference between the audio signal of voice and the audio signal of non-voice, and whether voice is present in the audio signal can be detected more accurately.

In S203, the time-frequency domain feature is processed through a classification layer in the voice activity detection model to obtain and output the voice presence detection result, where the voice activity detection model is configured to detect whether voice is present in the first audio signal.

The classification layer is used for classifying the time-frequency domain feature to obtain the voice presence detection result. Exemplarily, the classification layer includes a fully connected layer and a classifier. For example, the classifier may be a nonlinear activation function (Sigmoid). As described above, time-frequency domain features corresponding to multiple signal segments exist, and the classification layer can classify the time-frequency domain features of various signal segments to obtain the detection result that whether voice is present in each signal segment. Correspondingly, the voice presence detection result may include the detection result that in the first audio signal, voice is present in at least one signal segment, and/or voice is absent in at least one signal segment.

Optionally, the voice activity detection model includes at least one timing feature extraction layer. The step in which the feature extraction is performed on the frequency domain feature through the timing feature extraction layer in the voice activity detection model to obtain the time-frequency domain feature includes steps described below. Frame rate adjustment is performed on the frequency domain feature through the at least one timing feature extraction layer in the voice activity detection model to obtain an intermediate feature of at least one frame rate, and feature extraction is performed on the intermediate feature to obtain at least one unit feature corresponding to the at least one frame rate; and feature fusion is performed on the at least one unit feature through the voice activity detection model to obtain the time-frequency domain feature.

The number of timing feature extraction layers is at least one. In a case where at least two timing feature extraction layers exist, the connection relationship between the timing feature extraction layers is series connection or parallel connection. In the case where at least two timing feature extraction layers exist, different timing feature extraction layers are configured to extract features of different frame rates. The intermediate feature is a feature obtained after the frequency domain feature is subjected to the frame rate adjustment. The frame rate of the intermediate feature may be the same as or different from the frame rate of the frequency domain feature. The intermediate feature is used for representing frequency domain features of different frame rates.

The unit feature is a feature obtained by performing time domain feature extraction on an intermediate feature of a frame rate, and the frame rate of the unit feature is the same as the frame rate of the extracted intermediate feature. The unit feature is used for representing features extracted from frequency domain features of different frame rates, respectively. In a case where multiple timing feature extraction layers exist, multiple intermediate features exist, and each intermediate feature may be subjected to extraction to obtain a unit feature, so that multiple unit features are correspondingly obtained. Feature fusion is performed on the multiple unit features, and the obtained feature is the time-frequency domain feature.

Part of timing feature extraction layers in the voice activity detection model may be selected to perform frame rate adjustment on the frequency domain feature so as to obtain the intermediate feature of the at least one frame rate; or, all timing feature extraction layers in the voice activity detection model may be selected to perform frame rate adjustment on the frequency domain feature respectively to obtain the intermediate feature of the at least one frame rate. The timing feature extraction layers may be filtered randomly or be selected according to requirements. For example, according to the frame rate of the intermediate feature which may be obtained through adjustment, a corresponding timing feature extraction layer is selected to perform frame rate adjustment on the frequency domain feature; for example, a timing feature extraction layer is selected, where the frame rate of the unit feature output from the selected timing feature extraction layer is ¼ⁱ (i=1, 2, 3, . . . or n). The at least one timing feature extraction layer may perform frame rate adjustment of 1 on the frequency domain feature, that is, frame rate adjustment is not performed and only the feature extraction is performed. Moreover, part of unit features obtained through feature extraction layers may be selected for fusion to obtain the time-frequency domain feature; or all obtained unit features may be selected for fusion to obtain the time-frequency domain feature. The unit feature may be selected randomly or according to requirements. The unit feature may be selected according to the frame rate of the unit feature. For example, the unit feature of a median frame rate is selected.

In a specific example, frame rate adjustment is performed on the frequency domain feature through some timing feature extraction layer (or all timing feature extraction layers) in the voice activity detection model to obtain the intermediate feature of the at least one frame rate, and the feature extraction is performed to obtain at least one unit feature corresponding to the at least one frame rate; and the feature fusion is performed on some of the at least one unit feature (or all of the at least one unit feature) through the voice activity detection model to obtain the time-frequency domain feature.

Exemplarily, in the case where at least two timing feature extraction layers exist, one timing feature extraction layer performs time domain feature extraction based on the frequency domain feature, that is, performs time domain feature extraction based on the frequency domain feature of an original frame rate, and other timing feature extraction layers are configured to reduce the frame rate of the frequency domain feature and perform time domain feature extraction on the frequency domain feature of which the frame rate is reduced. In this manner, different timing feature extraction layers can extract richer time domain feature information from frequency domain features of different frame rates, and thus the representativeness of the time domain feature is improved.

In a specific example, for multiple timing feature extraction layers, one timing feature extraction layer performs time domain feature extraction on the frequency domain feature of the original frame rate to obtain the time-frequency domain feature, and other timing feature extraction layers may acquire a frequency domain feature of the frame rate being the quotient between the original frame rate and 2ⁱ and perform time domain feature extraction to obtain the time-frequency domain feature, where i=1, 2, 3, . . . or n. Exemplarily, the original frame rate is 1, and one timing feature extraction layer performs time domain feature extraction on a frequency domain feature of the frame rate being 1; other timing feature extraction layers perform time domain feature extraction on a frequency domain feature of the frame rate being 0.5, or perform time domain feature extraction on a frequency domain feature of the frame rate being 0.25. The number of timing feature extraction layers and the value of the frame rate may both be set according to requirements.

The frame rate adjustment may be achieved by reducing the number of frames of the feature. As described above, framing may be performed on the first audio signal to obtain multiple signal segments. One signal segment is a frame, and each signal may be subjected to extraction to obtain a corresponding frequency domain feature. Part of frames may be selected from the multiple signal segments, that is, the number of frames is reduced, and frequency domain features corresponding to the selected frames are taken as frequency domain features after the frame rate adjustment, that is, intermediate features. Fusing unit features of different frames rates may refer to that the frame rate of a unit feature of a low frame rate is improved, and then this unit feature of the improved frame rate is fused with a unit feature of a high frame rate, so as to obtain the time-frequency domain feature of the original frame rate. The fusion may be achieved through the manner of matrix addition, that is, element points corresponding to two matrices are added.

Multiple timing feature extraction layers are configured in the voice activity detection model, different timing feature extraction layers perform time domain feature extraction on frequency domain features of different frame rates, and the time-frequency domain feature is obtained by fusion. In this manner, time domain information with richer levels can be extracted from frequency domain features of different frame rates, the representativeness of the time-frequency domain feature can be improved, and the detection accuracy of voice activity detection can be improved.

Optionally, the voice activity detection model includes at least two serially connected timing feature extraction layers, a first timing feature extraction layer among at least two serially connected timing feature extraction layers includes a timing feature extraction model, and another timing feature extraction layer except the first timing feature extraction layer includes a timing feature extraction model and a frame skipping layer. The step in which the frame rate adjustment is performed on the frequency domain feature through the at least one timing feature extraction layer in the voice activity detection model to obtain the intermediate feature of the at least one frame rate, and the feature extraction is performed on the intermediate feature to obtain the at least one unit feature corresponding to the at least one frame rate includes steps described below. The frequency domain feature is taken as an intermediate feature of the first timing feature extraction layer; feature extraction is performed on the intermediate feature of the first timing feature extraction layer through the first timing feature extraction layer to obtain a unit feature output by the first timing feature extraction layer; frame skipping processing is performed on a unit feature output by a former serially connected timing feature extraction layer through the another timing feature extraction layer to obtain an intermediate feature of the another timing feature extraction layer; and feature extraction is performed on the intermediate feature of the another timing feature extraction layer through the another timing feature extraction layer to obtain a unit feature output by the another timing feature extraction layer; where a frame rate of the unit feature output by the timing feature extraction layer is the same as a frame rate of the intermediate feature of the timing feature extraction layer.

A serial connection relationship exists between the timing feature extraction layers. The input of the first timing feature extraction layer is the frequency domain feature. The input of the another timing feature extraction layer except the first timing feature extraction layer is the output of the former serially connected timing feature extraction layer.

The first timing feature extraction layer performs feature extraction on the feature of the original frame rate and does not need to perform frame rate adjustment on the input. Thus, the input of the first timing feature extraction layer, that is, the frequency domain feature, may be directly determined as the intermediate feature of the first timing feature extraction layer. Correspondingly, the first timing feature extraction layer does not include a frame skipping layer and only includes the timing feature extraction model. The timing feature extraction model included in the first timing feature extraction layer is configured to perform feature extraction on the intermediate feature, that is, the frequency domain feature, to obtain the unit feature output by the first timing feature extraction layer. Another timing feature extraction layer serially connected to the first timing feature extraction layer determines the unit feature of the first timing feature extraction layer as the input. The unit feature is input into the frame skipping layer of the another timing feature extraction layer, and the frame rate of the unit feature is adjusted, so as to obtain the intermediate feature of the another timing feature extraction layer; and the intermediate feature of the another timing feature extraction layer is input into the timing feature extraction model of the another timing feature extraction layer to perform feature extraction, so as to obtain the unit feature output by the another timing feature extraction model.

For another remaining timing feature extraction layer, the unit feature output by the former serially connected timing feature extraction layer is input into a frame skipping layer of the another remaining timing feature extraction layer for frame skipping processing to obtain an intermediate feature of the another remaining timing feature extraction layer; and feature extraction is performed on the intermediate feature of the another remaining timing feature extraction layer through a timing feature extraction model of the another remaining timing feature extraction layer to obtain a unit feature of the another remaining timing feature extraction layer. Similarly, unit features output by various other timing feature extraction layers are obtained.

The frame skipping layer is used for adjusting the frame rate of an input feature, and, for example, for performing frame skipping processing on the input feature. The frame skipping processing may refer to that, for features of multiple frames, features of part of the multiple frames may be eliminated, and features of reserved frames are determined as features after the frame rate is adjusted. Optionally, the manner of frame skipping processing of reducing the frame rate to half of the original frame rate may be that features of various frames are divided into groups temporally, each group includes features of two consecutive frames, and the feature of the first frame ranking first in the timing is retained and the feature of the second frame ranking last in the timing is eliminated for each group, so that features of half of the frames are eliminated, and the feature of which the frame rate is the half of the original frame rate is obtained. The timing feature extraction model is configured to perform time domain feature extraction on an input feature. It is to be noted that the timing feature extraction model does not change the frame rate, and the frame rate of the input of the timing feature extraction model is the same as the frame rate of the output of the timing feature extraction model, that is, the frame rate of the intermediate feature input into the timing feature extraction model is the same as the frame rate of the unit feature output by the timing feature extraction model.

It is to be noted that in the process of training the voice activity detection model, a loss function may be calculated, and parameters of at least one timing feature extraction model are adjusted until the training is completed.

Multiple serially connected timing feature extraction layers are configured, and frame skipping layers are configured in other timing feature extraction layers except the first timing feature extraction layer for frame rate adjustment, so that the frame rate of the feature is reduced step by step; feature extraction is performed on features of different frame rates through the timing feature extraction model included in at least one timing feature extraction layer, so that information of features in time domains of different frame rates is increased; moreover, the structure of the serially connected timing feature extraction layers can increase the depth of the model, and thus the timing feature extraction layer at a deep level can extract higher-dimensional features for fusion with lower-dimensional features, which enriches the content of the fused features, increases the representativeness of the features, and improves the detection accuracy of voice activity detection.

Optionally, the step in which the feature fusion is performed on the at least one unit feature through the voice activity detection model to obtain the time-frequency domain feature includes steps described below. Frame rate adjustment is performed on a unit feature of a first frame rate through the voice activity detection model, and the unit feature subjected to the frame rate adjustment is fused with a unit feature of a second frame rate, where the first frame rate is less than the second frame rate, and the unit feature subjected to the frame rate adjustment has the second frame rate; and unit features of various frame rates are fused to obtain a result as the time-frequency domain feature.

The first frame rate is less than the second frame rate, and frame rates of various unit features are different. The unit feature of the first frame rate may be subjected to frame rate enhancement to reach the second frame rate and thus to be subjected to feature fusion with the unit feature of the second frame rate. Then, the result of the feature fusion of the second frame rate is taken as a unit feature of a new first frame rate, and the unit feature of the new first frame is subjected to frame rate enhancement to reach a new second frame rate and to be subjected to a unit feature of the new second frame rate. Similarly, a result of feature fusion of the highest frame rate is finally obtained and determined as the time-frequency domain feature. Exemplarily, a unit feature of the frame rate being 0.25, a unit feature of the frame rate being 0.5 and a unit feature of the frame rate being 1 exist. The unit feature of the first frame rate, that is, the frame rate being 0.25, is adjusted as a feature of the second frame rate, that is, the frame rate being 0.5, and then is fused with the unit feature of the second frame rate, that is, the frame rate being 0.5, to obtain a fusion result. Then, the first frame rate is updated to 0.5, and the new second frame rate is 1. The fusion result of the new first frame rate, that is, the frame rate being 0.5, is adjusted as a feature of the new second frame rate, that is, the frame rate being 1 and is fused with the unit feature of the new second frame rate, that is, the frame rate being 1, to obtain a fusion result of the frame rate being 1, which is determined as the time-frequency domain feature.

Moreover, various unit features may also be adjusted as features of the highest frame rate for fusion to obtain a fused result as the time-frequency domain feature. The method for enhancing the frame rate may be performing upsampling on a feature of a relatively low frame rate to obtain a feature of a relatively high frame rate. For example, upsampling is performed on the feature of the first frame rate to obtain a feature of the second frame rate.

The feature of the relatively low frame rate is adjusted as a feature of the relatively high frame rate and is subjected to feature fusion with the feature of the relatively high frame rate, so as to obtain a fused feature of the original frame rate as the time-frequency domain feature. In this manner, the consistency of the input and the output of the model is achieved, and the complexity of data processing is reduced; at the same time, features of different frame rates are accurately fused, so that the time domain information in features of different frame rates is enriched, and the detection accuracy of voice activity detection is improved.

Optionally, different timing feature extraction layers have different widths.

The width of a timing feature extraction layer is used for determining the scale of the timing feature extraction layer. For different models, parameters for determining the widths of the models are different. Exemplarily, if the timing feature extraction layer is a convolutional neural network, what determines the width of the model is the number of channels of a convolutional layer in the timing feature extraction layer. If the timing feature extraction layer is an LSTM, what determines the width of the model is the number of nodes in a hidden layer of the timing feature extraction layer. It is to be noted that the scale of the model or the size of the space occupied by the structure of the model is determined by the depth and the width of the model. The depth of the model may be the number of various function layers included in the structure. The width of the model may be the size of the various function layers included in the structure.

In fact, different timing feature extraction layers perform feature extraction for different frame rates, and since the amount of data that need to be calculated for features of different frame rates are different, the different timing feature extraction layers correspond to different complexity of structures for calculation. Therefore, to reduce the amount of data that needs to be calculated and the calculation complexity, a timing feature extraction layer having a small width may be selected for feature extraction for high frame rates, so as to reduce the calculation amount and the calculation complexity caused by the high frame rates. For example, a timing feature extraction layer having a small width may be configured to process an intermediate feature of a high frame rate, and a timing feature extraction layer having a large width may be configured to process an intermediate feature of a low frame rate, so that the calculation amount and the calculation complexity of feature extraction for different frame rates are reduced.

Different timing feature extraction layers having different widths are configured, so that the calculation amount of feature extraction and the calculation complexity can be flexibly adjusted, thus the calculation complexity is reduced, a lightweight voice activity detection model is deployed, and the running cost of the model is reduced.

According to the technical solutions of the present disclosure, time domain feature extraction is performed on the frequency domain feature through the timing feature extraction layer in the voice activity detection model to obtain the time-frequency domain feature, and the extracted time-frequency domain feature is classified through the classification layer in the voice activity detection model to obtain the voice presence detection result. In this manner, the capability of the timing feature extraction layer to learn time-continuous voice features is improved, thus the time-frequency domain feature can better characterize the difference between the audio signal of voice and the audio signal of non-voice, the representativeness of the time-frequency domain feature can be improved, whether voice is present in the audio signal can be detected more accurately, and the accuracy of voice activity detection is improved.

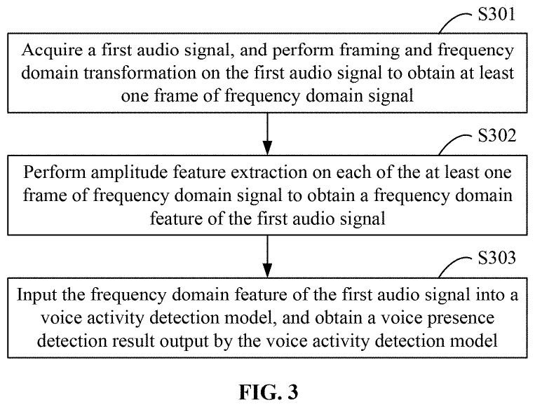

FIG. 3 is a flowchart of another voice activity detection method according to an embodiment of the present disclosure. The method is further optimized and extended based on the preceding technical solutions and may be combined with the preceding various optional embodiments. The step in which the frequency domain feature of the first audio signal is extracted is specified as follows. Framing and frequency domain transformation are performed on the first audio signal to obtain at least one frame of frequency domain signal; and amplitude feature extraction is performed on each of the at least one frame of frequency domain signal to obtain the frequency domain feature of the first audio signal.

In S301, a first audio signal is acquired, and framing and frequency domain transformation are performed on the first audio signal to obtain at least one frame of frequency domain signal.

The first audio signal is generally represented in the form of time domain waveforms. Performing framing on the first audio signal may refer to dividing the first audio signal temporally to obtain signal segments, and each signal segment is taken as a frame. Exemplarily, framing is performed on a first audio signal of four seconds, the duration of one frame is one second, and thus four temporally consecutive frames of signals can be obtained.

Current signals after the framing are still time domain signals, and the time domain signals may be subjected to frequency domain conversion to be converted into frequency domain signals for frequency domain feature extraction. The frequency domain conversion may be achieved in manners of the Fourier transform, etc.

In S302, amplitude feature extraction is performed on each of the at least one frame of frequency domain signal to obtain a frequency domain feature of the first audio signal.

Performing amplitude feature extraction on the each of the at least one frequency domain signal actually refers to performing frequency spectral analysis on the frequency domain signal to obtain amplitude information of different frequencies, and the amplitude information is determined as the frequency domain feature. For example, spectral analysis refers to acquiring amplitude information of each frame at different frequencies. Exemplarily, the amplitude information may be obtained by using the manner of subband spectral analysis. The amplitude information obtained from the spectral analysis is determined as the amplitude feature and further, as the frequency domain feature.

Exemplarily, the spectral analysis may be achieved by extracting different types of features such as a fundamental tone, a harmonic, a linear prediction coefficient, an autocorrelation coefficient, a short-term zero-crossing rate, a long-term zero-crossing rate, short-term energy, amplitude and a phase. For a voice signal, amplitude information in the voice signal is more representative of the difference between the voice signal and a non-voice signal. Thus, the information characterizing the amplitude in the first audio signal can be accurately extracted and determined as the frequency domain feature, so that the model can better learn the frequency domain feature in the voice signal, and thereby whether voice is present is accurately detected.

In S303, the frequency domain feature of the first audio signal is input into a voice activity detection model, and a voice presence detection result output by the voice activity detection model is obtained, where the voice activity detection model is configured to detect whether voice is present in the first audio signal.

Optionally, the step in which the amplitude feature extraction is performed on the each of the at least one frame of frequency domain signal to obtain the frequency domain feature of the first audio signal includes the step described below. The amplitude feature extraction is performed on the each of the at least one frame of frequency domain signal to obtain an alternative amplitude feature; and data compression is performed on the alternative amplitude feature to obtain the frequency domain feature of the first audio signal.

The alternative amplitude feature of the frequency domain signal is used for representing amplitude information of the frequency domain signal. The alternative amplitude feature obtained by amplitude feature extraction generally involves a large amount of data, and the data may be compressed to obtain the frequency domain feature, so that the amount of data of the feature is reduced, the amount of data that needs to be processed is reduced, and the efficiency of data processing is improved.

The data compression may be achieved by using a function for data procession to process the alternative amplitude feature to obtain the frequency domain feature. Exemplarily, a logarithm (log) or an operation of extracting an n-th root may be used. Exemplarily, the amplitude feature extraction may be achieved by using a log amplitude spectrum feature algorithm to perform feature extraction on the frequency-domain signal, and thus to obtain the frequency-domain feature. The frequency domain feature output may be calculated based on the following formula:

output=log|input+10⁻⁸|.

In this formula, input is the alternative amplitude feature, and log is a logarithmic function. 10⁻⁸ is a preset constant for adjusting the numerical range of the frequency domain feature output.

Amplitude feature extraction is performed on the frequency domain signal to obtain the alternative amplitude feature, and data compression is performed to obtain the frequency domain feature within a relatively small numerical range, so that the amount of data of the feature is reduced, the amount of data that needs to be processed is reduced, and the efficiency of data processing is improved.

According to the technical solutions of the present disclosure, framing and frequency domain transformation are performed on the first audio signal, and amplitude feature extraction is performed on the obtained frequency domain signal to obtain the frequency domain feature. In this manner, the amplitude information that better ensures the difference between the voice signal and the non-voice signal is determined as the frequency domain feature, so that the model can better learn the frequency domain feature difference between the voice signal and the non-voice signal, and the accuracy of voice activity detection is improved.

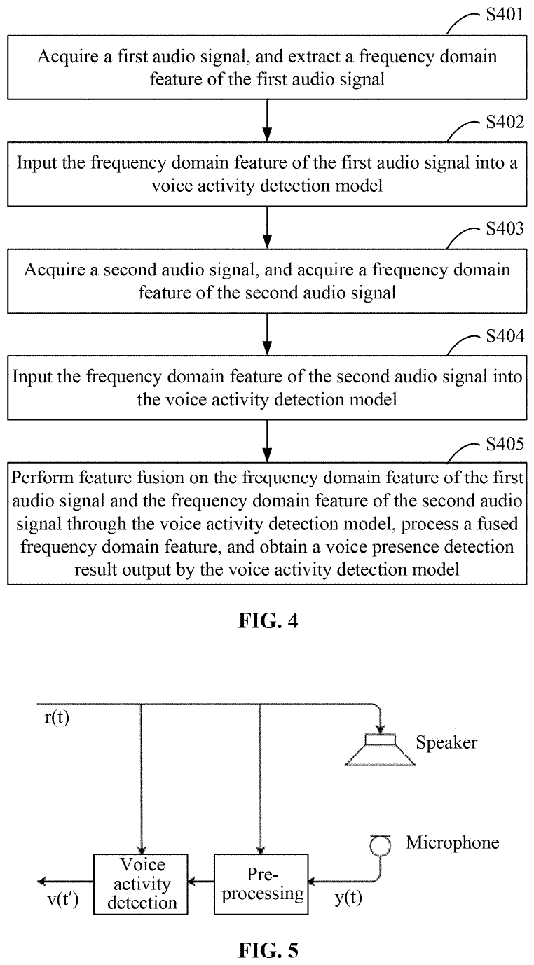

FIG. 4 is a flowchart of another voice activity detection method according to an embodiment of the present disclosure. The method is further optimized and extended based on the preceding technical solutions and may be combined with the preceding various optional embodiments. The voice activity detection method is optimized as follows. A second audio signal is acquired, and a frequency domain feature of the second audio signal is extracted, where the second audio signal is taken as an interference reference signal of the first audio signal; the frequency domain feature of the second audio signal is input into the voice activity detection model. The step in which the voice presence detection result output by the voice activity detection model is obtained is specified as follows. Feature fusion is performed on the frequency domain feature of the first audio signal and the frequency domain feature of the second audio signal through the voice activity detection model, a fused frequency domain feature is processed, and the voice presence detection result output by the voice activity detection model is obtained.

In S401, a first audio signal is acquired, and a frequency domain feature of the first audio signal is extracted.

In S402, the frequency domain feature of the first audio signal is input into a voice activity detection model.

In S403, a second audio signal is acquired, and a frequency domain feature of the second audio signal is acquired, where the second audio signal is taken as an interference reference signal of the first audio signal.

The second audio signal is taken as the interference reference signal of the first audio signal. Optionally, the second audio signal is at least one interference signal of the first audio signal except a valid signal, forming an audio signal. Exemplarily, the valid signal is a voice signal of a user. The interference signal may include at least one of: a noise signal in the environment, a voice signal of other users in the environment, or an echo signal in a communication scene, etc. Echoes refer to the voice of a talking user. Exemplarily, the first audio signal is an audio signal directly collected from a near end in a communication scene, and the second audio signal is an audio signal transmitted by a communication terminal. The first audio signal includes echoes, voice of a user and noises. The valid signal is the voice of the user, and echoes and noises are interference signals. The second audio signal may include echoes. Correspondingly, the second audio signal is used for reducing echoes in the first audio signal, so that in an application scene where echoes exist, echoes and the voice of the near-end user are distinguished, and the accuracy of the voice presence detection is improved. Optionally, the first audio signal is an audio signal acquired by a microphone. The second audio signal is an audio signal input into a speaker for playing. The method for extracting the frequency domain feature from the first audio signal may be used for extracting the frequency domain feature from the second audio signal.

Moreover, the audio signal collected by the microphone may also be pre-processed to obtain the first audio signal. The pre-processing includes, but is not limited to, echo cancellation, noise suppression processing, etc. Exemplarily, as shown in FIG. 5, r(t) is a far-end reference signal, that is, the second audio signal, and is also a received voice signal of a talking user, that is, a voice signal to be input to the speaker for playing, and y(t) is a near-end signal collected by the microphone, that is, the first audio signal. v(t′) is a target audio signal, and the target audio signal is, for example, an audio signal obtained by removing a signal segment without voice from the first audio signal according to a voice presence detection result of the first audio signal output by the voice activity detection model.

In S404, the frequency domain feature of the second audio signal is input into the voice activity detection model.

The frequency domain feature of the second audio signal is input into the voice activity detection model as a reference for the frequency domain feature of the first audio signal.

In S405, feature fusion is performed on the frequency domain feature of the first audio signal and the frequency domain feature of the second audio signal through the voice activity detection model, a fused frequency domain feature is processed, and a voice presence detection result output by the voice activity detection model is obtained, where the voice activity detection model is configured to detect whether voice is present in the first audio signal.

The voice activity detection model may include a feature fusion layer. The feature fusion layer is used for fusing the frequency domain feature of the first audio signal and the frequency domain feature of the second audio signal to obtain the fused feature. Optionally, the step in which the frequency domain feature of the first audio signal is input into the voice activity detection model, and the voice presence detection result output by the voice activity detection model is obtained may include steps described below. Feature extraction is performed on the fused frequency domain feature through a timing feature extraction layer in the voice activity detection model to obtain a time-frequency domain feature; and the time-frequency domain feature is processed through a classification layer in the voice activity detection model to obtain and output the voice presence detection result.

The feature fusion layer is used for performing channel combination on the frequency domain feature of the first audio signal and the frequency domain feature of the second audio signal, and performing feature fusion on the frequency domain feature after the channel combination. Exemplarily, the frequency domain feature of the first audio signal is a C1*W*H matrix, the frequency domain feature of the second audio signal is a C2*W*H matrix, and the frequency domain feature obtained after the channel combination is a (C1+C2)*W*H matrix. Generally, the frequency domain feature of the first audio signal is a matrix of a single channel, and the frequency domain feature of the second audio signal is a matrix of a single channel, and after the channel combination, a matrix of two channels is obtained. In a specific example, the frequency domain feature of the first audio signal is a 4*4 matrix, the frequency domain feature of the second audio signal is a 4*4 matrix, and the frequency domain feature obtained after the channel combination is a 2*4*4 matrix. The feature fusion layer includes at least one convolutional layer, and feature fusion performed on the frequency domain feature after the channel combination actually refers to the convolution calculation performed on the frequency domain feature after the channel combination by using a convolution kernel. In a specific example, the frequency domain feature obtained by the channel combination is a 2*4*4 matrix, the convolution kernel is a 2*4 matrix, and the fused feature is a 4*4*4 matrix obtained by the convolution calculation performed in terms of the channel dimension.

It is to be noted that in the process of training the voice activity detection model, a loss function may be calculated, and parameters of the convolutional layer are adjusted until the training is completed.

According to the technical solutions of the present disclosure, the second audio signal as the interference reference signal of the first audio signal is acquired, the frequency domain feature of the second audio signal is extracted, feature fusion is performed on the frequency domain feature of the first audio signal and the frequency domain feature of the second audio signal, and processing is performed based on the fused feature, so as to recognize whether voice is present in the first audio signal. In this manner, the interference of the interference signal in the first audio signal to the voice presence result can be reduced, and the detection accuracy of the voice activity detection of the first audio signal can be improved.

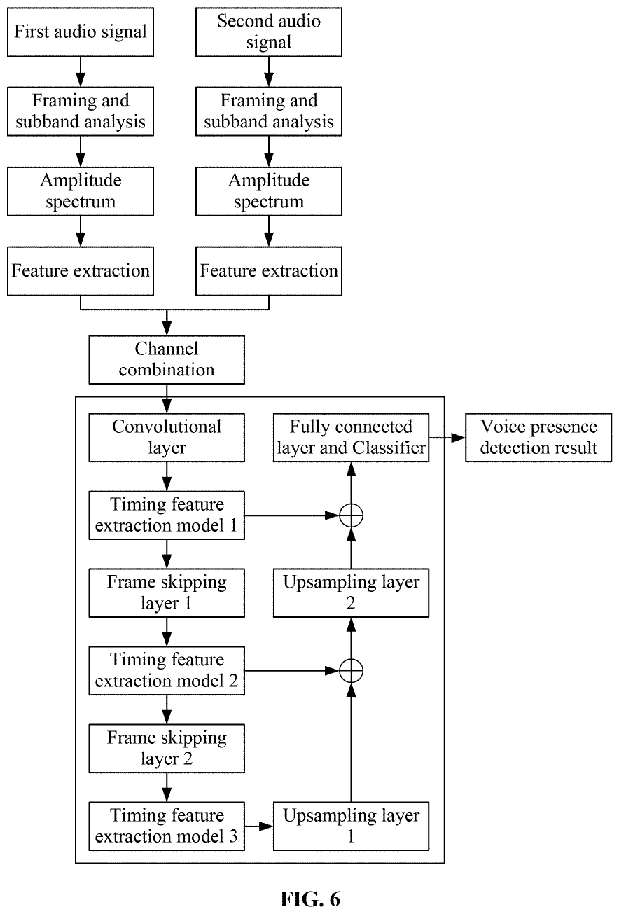

FIG. 6 is a scene graph of another voice activity detection method according to an embodiment of the present disclosure. As shown in FIG. 6, the voice activity detection model includes a convolutional layer, three serially connected timing feature extraction layers, two upsampling layers and a classification layer. The first timing feature extraction layer includes timing feature extraction model 1, the second timing feature extraction layer serially connected to the first timing feature extraction layer includes frame skipping layer 1 and timing feature extraction model 2, and the third timing feature extraction layer serially connected to the second timing feature extraction layer includes frame skipping layer 2 and timing feature extraction model 3. The classification layer includes a fully connected layer and a classifier, and the classifier may be a Sigmoid function.

The process for training the voice activity detection model may be as follows. A training sample is acquired; and then the voice activity detection model is trained. That is, parameters of the convolutional layer and parameters of the three serially connected timing feature extraction layers in the voice activity detection model are adjusted. In a case where the number of iterations is greater than or equal to a preset threshold or the result of a loss function converges, it may be determined that the training of the voice activity detection model is completed. The training sample includes voice signals, echo signals and non-voice signals collected by a microphone.

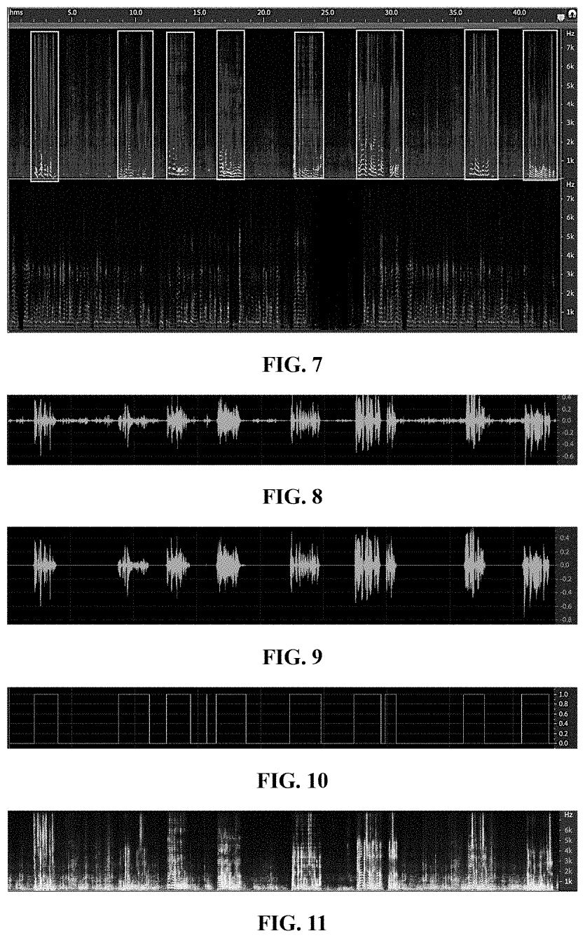

The running process of the voice activity detection model may be described below. The input of the voice activity detection model is two channels, where channel 1 is a microphone channel for acquiring a first audio signal, and channel 2 is a reference channel for acquiring a second audio signal. Exemplarily, as shown in FIG. 7, waveforms in the top half of the figure represent the first audio signal with a residual echo signal and background noises. Waveforms of the bottom half of the figure represent an echo signal, that is, the second audio signal. The signals of the two channels are subjected to framing and subband analysis respectively to obtain spectrum output, and corresponding amplitude spectrums are obtained. The spectrum output of the two channels is subjected to feature extraction separately, for example, log amplitude spectrum features are extracted. The features of the two channels are subjected to channel combination to form the input of the voice activity detection model, that is, the frequency domain features, and at this time, the frame rate of the frequency domain features is 1. The frequency domain features of the two channels are fused through the convolutional layer of the voice activity detection model. Frame skipping is not performed in the fusion process, and the frame rate of the output fused frequency domain feature is still 1. Moreover, echo signal is absent in some scenes such as a non-talking scene. In this case, the second audio signal may be set null, for example, may be set to zero, such that the second audio signal is absent, and thus only the first audio signal is processed.

The fused frequency domain feature is input into the first timing feature extraction layer in the voice activity detection model, that is, in timing feature extraction model 1, feature extraction is performed on the frequency domain feature of the frame rate being 1, and a unit feature of the first timing feature extraction layer and output by timing feature extraction model 1 is obtained. The unit feature output by the first timing feature extraction layer is input into the second serially connected timing feature extraction layer, frame skipping processing is performed on the unit feature of the first timing feature extraction layer through frame skipping layer 1 in the second timing feature extraction layer to obtain an intermediate feature of the frame rate being 0.5 times, and feature extraction is performed on the intermediate feature of the frame rate being 0.5 times through timing feature extraction model 2 in the second timing feature extraction layer to obtain a unit feature of the frame rate being 0.5 times of the second timing feature extraction layer and output by timing feature extraction model 2. The unit feature output by the second timing feature extraction layer is input into the third serially connected timing feature extraction layer, frame skipping processing is performed on the unit feature of the second timing feature extraction layer through frame skipping layer 2 in the third timing feature extraction layer to obtain an intermediate feature of the frame rate being 0.25 times, and feature extraction is performed on the intermediate feature of the frame rate being 0.25 times through timing feature extraction model 3 in the third timing feature extraction layer to obtain a unit feature of the frame rate being 0.25 times of the third timing feature extraction layer and output by timing feature extraction model 3. In this manner, the input frequency domain feature is modeled at different frame rates, that is, a time domain feature is extracted. In addition, since the subsequent frame rate of the timing feature extraction model is relatively low, the call frequency is also relatively low, and thus the calculation amount can be controlled.

The embodiment here only illustrates the voice activity detection model involving two times of frame skipping, more times of frame skipping can further improve the accuracy of the detection of the model without greatly increasing the calculation amount of the model. The number of times of frame skipping, that is, the number of timing feature extraction layers, may be set according to requirements.

At this time, due to the introduction of frame skipping, frame rates of unit features output by different timing feature extraction layers are not the same. To ensure that the frame rate of the output is 1, multi-level upsampling layers may be used. The upsampling layer of each level doubles the frame rate, and the unit feature of which the frame rate is doubled is added to the unit feature of the same frame rate output by the timing feature extraction layer to obtain the output.

After the processing by the multi-level upsampling layers, the frame rate of the fused feature is restored to 1. Finally, through the activation by the fully connected layer in the classification layer and the Sigmoid function, the voice presence probability within the range from 0 to 1 is calculated as the voice activity detection result.

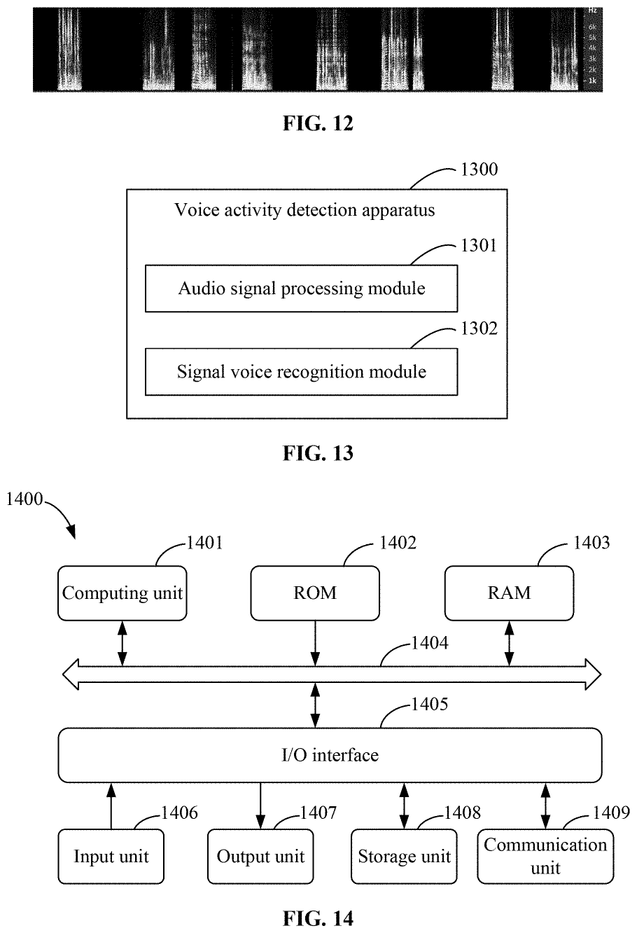

After the voice activity detection result is acquired, the first audio signal may be processed to eliminate residual echoes and background noises, so as to obtain information retaining only a target voice signal. The background noises may include stationary noises and non-stationary noises. Exemplarily, as shown in FIG. 8, waveforms represent an original microphone signal, that is, the original first audio signal. As shown in FIG. 9, waveforms represent the first audio signal obtained after echoes and noises are removed according to the voice activity detection result. As shown in FIG. 10, waveforms represent the voice activity detection result, where the high level represents that the probability of voice being present is 1, that is, represents the detection result of voice being present, and the low level represents that the probability of voice being present is 0, that is, represents the detection result of voice being absent. As shown in FIG. 11, waveforms represent the amplitude spectrum of the first audio signal. As shown in FIG. 12, waveforms represent the amplitude spectrum of the first audio signal obtained after echoes and noises are removed according to the voice activity detection result. It can be seen, whether from the time domain or the frequency domain, that the target voice signal (voice of a target user) can be accurately detected even in a scene where loud noises and residual echoes exist.

According to the technical solutions of the present disclosure, voice activity detection is performed through the deep learning model, so that the detection accuracy is improved, the generalization capability is enhanced, and the adjustment is simplified; the layered frame skipping mechanism is introduced, so that the calculation amount of the voice activity detection model is greatly reduced, and thus the voice activity detection model can be applied in an embedded device with low power consumption; moreover, the reference signal is introduced, so that the voice activity detection model is capable of distinguishing residual echoes, and thus the target voice can be accurately detected in a scene where residual echoes exist.

According to the embodiments of the present disclosure, FIG. 13 is a structural diagram of a voice activity detection apparatus according to an embodiment of the present disclosure. The embodiment of the present disclosure is applicable to a case of performing voice activity detection on an audio in video streaming. The apparatus is implemented by software and/or hardware and is configured in an electronic device having a certain data computing capability.

The voice activity detection apparatus 1300 shown in FIG. 13 includes an audio signal processing module 1301 and a signal voice recognition module 1302.

The audio signal processing module 1301 is configured to acquire a first audio signal, and extract a frequency domain feature of the first audio signal.

The signal voice recognition module 1302 is configured to input the frequency domain feature of the first audio signal into a voice activity detection model, and obtain a voice presence detection result output by the voice activity detection model, where the voice activity detection model is configured to detect whether voice is present in the first audio signal.

According to the technical solutions of the present disclosure, the frequency domain feature of the first audio signal is extracted, the frequency domain feature is input into the voice activity detection model for processing, and the voice presence detection result is obtained. In this manner, the frequency domain feature of the first audio signal is effectively extracted, the feature extraction operations by the voice activity detection model are reduced, so that the calculation complexity of the voice activity detection model is reduced, the detection complexity of voice activity detection is reduced, and lightweight voice activity detection is achieved. Moreover, the detection efficiency of voice activity detection is improved, the feature representing the audio signal is accurately extracted, so that the representativeness of the frequency domain feature is improved, and the detection accuracy of voice activity detection is improved.

Further, the signal voice recognition module 1302 includes a time-frequency domain feature extraction unit and a time-frequency domain feature classification unit. The time-frequency domain feature extraction unit is configured to perform feature extraction on the frequency domain feature through a timing feature extraction layer in the voice activity detection model to obtain a time-frequency domain feature, where the timing feature extraction layer is configured to perform time domain feature extraction on the frequency domain feature; and the time-frequency domain feature classification unit is configured to process the time-frequency domain feature through a classification layer in the voice activity detection model to obtain and output the voice presence detection result.

Further, the voice activity detection model includes at least one timing feature extraction layer. The time-frequency domain feature extraction unit includes a feature frame rate adjustment subunit and a feature fusion subunit. The feature frame rate adjustment subunit is configured to perform frame rate adjustment on the frequency domain feature through the at least one timing feature extraction layer in the voice activity detection model to obtain an intermediate feature of at least one frame rate, and perform feature extraction on the intermediate feature to obtain at least one unit feature corresponding to the at least one frame rate; and the feature fusion subunit is configured to perform feature fusion on the at least one unit feature through the voice activity detection model to obtain the time-frequency domain feature.

Further, the voice activity detection model includes at least two serially connected timing feature extraction layers, a first timing feature extraction layer includes a timing feature extraction model, and another timing feature extraction layer except the first timing feature extraction layer includes a timing feature extraction model and a frame skipping layer. The feature frame rate adjustment subunit is further configured to: take the frequency domain feature as an intermediate feature of the first timing feature extraction layer; perform feature extraction on the intermediate feature of the first timing feature extraction layer through the first timing feature extraction layer to obtain a unit feature output by the first timing feature extraction layer; perform frame skipping processing on a unit feature output by a former serially connected timing feature extraction layer through the another timing feature extraction layer to obtain an intermediate feature of the another timing feature extraction layer; and perform feature extraction on the intermediate feature of the another timing feature extraction layer through the another timing feature extraction layer to obtain a unit feature output by the another timing feature extraction layer; where a frame rate of the unit feature output by the timing feature extraction layer is the same as a frame rate of the intermediate feature of the timing feature extraction layer.

Further, the feature fusion subunit is further configured to: perform frame rate adjustment on a unit feature of a first frame rate through the voice activity detection model, and fuse the unit feature subjected to the frame rate adjustment with a unit feature of a second frame rate, where the first frame rate is less than the second frame rate, and the unit feature subjected to the frame rate adjustment has the second frame rate; and fuse unit features of various frame rates to obtain a result as the time-frequency domain feature.

Further, different timing feature extraction layers have different widths.

Further, the audio signal processing module includes a signal spectral analysis unit and an amplitude feature extraction unit. The signal spectral analysis unit is configured to perform framing and frequency domain transformation on the first audio signal to obtain at least one frame of frequency domain signal; and the amplitude feature extraction unit is configured to perform amplitude feature extraction on each of the at least one frame of frequency domain signal to obtain the frequency domain feature of the first audio signal.

Further, the amplitude feature extraction unit includes an alternative amplitude feature determination subunit and an amplitude feature compression subunit. The alternative amplitude feature determination subunit is configured to perform the amplitude feature extraction on the each of the at least one frame of frequency domain signal to obtain an alternative amplitude feature; and the amplitude feature compression subunit is configured to perform data compression on the alternative amplitude feature to obtain the frequency domain feature of the first audio signal.

Further, the voice activity detection apparatus further includes a second audio signal acquisition module and a second audio signal processing module. The second audio signal acquisition module is configured to acquire a second audio signal, and extract a frequency domain feature of the second audio signal, where the second audio signal is taken as an interference reference signal of the first audio signal; and the second audio signal processing module is configured to input the frequency domain feature of the second audio signal into the voice activity detection model. The signal voice recognition module 1302 includes a frequency domain feature fusion unit. The frequency domain feature fusion unit is configured to perform feature fusion on the frequency domain feature of the first audio signal and the frequency domain feature of the second audio signal through the voice activity detection model, process a fused frequency domain feature, and obtain the voice presence detection result output by the voice activity detection model.

The preceding voice activity detection apparatus may execute the voice activity detection method provided by any embodiment of the present disclosure and has corresponding functional modules for and beneficial effects of executing the voice activity detection method.

In the technical solutions of the present disclosure, the collection, storage, use, processing, transmission, provision, and disclosure of user personal information involved are in compliance with provisions of relevant laws and regulations and do not violate public order and good customs.

According to an embodiment of the present disclosure, the present disclosure further provides an electronic device, a readable storage medium and a computer program product.

FIG. 14 is a block diagram illustrative of an exemplary electronic device 1400 that may be used for implementing the embodiments of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 14, the device 1400 includes a computing unit 1401. The computing unit 1401 may perform various appropriate actions and processing according to a computer program stored in a read-only memory (ROM) 1402 or a computer program loaded into a random-access memory (RAM) 1403 from a storage unit 1408. Various programs and data required for the operation of the device 1400 may also be stored in the RAM 1403. The computing unit 1401, the ROM 1402, and the RAM 1403 are connected to each other through a bus 1404. An input/output (I/O) interface 1405 is also connected to the bus 1404.

Multiple components in the device 1400 are connected to the I/O interface 1405. The multiple components include an input unit 1406 such as a keyboard or a mouse, an output unit 1407 such as various types of displays or speakers, the storage unit 1408 such as a magnetic disk or an optical disc, and a communication unit 1409 such as a network card, a modem or a wireless communication transceiver. The communication unit 1409 allows the device 1400 to exchange information/data with other devices over a computer network such as the Internet and/or various telecommunications networks.

The computing unit 1401 may be various general-purpose and/or special-purpose processing components having processing and computing capabilities. Examples of the computing unit 1401 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 1401 executes various methods and processing described above, such as the voice activity detection method. For example, in some embodiments, the voice activity detection method may be implemented as computer software programs tangibly contained in a machine-readable medium such as the storage unit 1408. In some embodiments, part or all of computer programs may be loaded and/or installed on the device 1400 via the ROM 1402 and/or the communication unit 1409. When the computer programs are loaded to the RAM 1403 and executed by the computing unit 1401, one or more steps of the preceding voice activity detection method may be executed. Alternatively, in other embodiments, the computing unit 1401 may be configured, in any other suitable manner (for example, by means of firmware), to execute the voice activity detection method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the method of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, a server of a distributed system, or a server combined with a blockchain.

It is to be understood that various forms of the preceding flows may be used with steps reordered, added, or removed. For example, the steps described in the present disclosure may be executed in parallel, in sequence or in a different order as long as the desired results of the technical solutions disclosed in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A voice activity detection method, comprising:
acquiring a first audio signal, and extracting a frequency domain feature of the first audio signal; and
inputting the frequency domain feature of the first audio signal into a voice activity detection model, and obtaining a voice presence detection result output by the voice activity detection model, wherein the voice activity detection model is configured to detect whether voice is present in the first audio signal.

2. The method according to claim 1, wherein inputting the frequency domain feature of the first audio signal into the voice activity detection model, and obtaining the voice presence detection result output by the voice activity detection model comprises:
performing feature extraction on the frequency domain feature through a timing feature extraction layer in the voice activity detection model to obtain a time-frequency domain feature, wherein the timing feature extraction layer is configured to perform time domain feature extraction on the frequency domain feature; and
processing the time-frequency domain feature through a classification layer in the voice activity detection model to obtain and output the voice presence detection result.

3. The method according to claim 2, wherein the voice activity detection model comprises at least one timing feature extraction layer; and
wherein performing the feature extraction on the frequency domain feature through the timing feature extraction layer in the voice activity detection model to obtain the time-frequency domain feature comprises:
performing frame rate adjustment on the frequency domain feature through the at least one timing feature extraction layer in the voice activity detection model to obtain an intermediate feature of at least one frame rate, and performing feature extraction on the intermediate feature to obtain at least one unit feature corresponding to the at least one frame rate; and
performing feature fusion on the at least one unit feature through the voice activity detection model to obtain the time-frequency domain feature.

4. The method according to claim 3, wherein the voice activity detection model comprises at least two serially connected timing feature extraction layers, a first timing feature extraction layer among the at least two timing feature extraction layers comprises a timing feature extraction model, and another timing feature extraction layer except the first timing feature extraction layer comprises a timing feature extraction model and a frame skipping layer; and
wherein performing the frame rate adjustment on the frequency domain feature through the at least one timing feature extraction layer in the voice activity detection model to obtain the intermediate feature of the at least one frame rate, and performing the feature extraction on the intermediate feature to obtain the at least one unit feature corresponding to the at least one frame rate comprises:
taking the frequency domain feature as an intermediate feature of the first timing feature extraction layer;
performing feature extraction on the intermediate feature of the first timing feature extraction layer through the first timing feature extraction layer to obtain a unit feature output by the first timing feature extraction layer;
performing, through the another timing feature extraction layer, frame skipping processing on a unit feature output by a former serially connected timing feature extraction layer to obtain an intermediate feature of the another timing feature extraction layer; and
performing, through the another timing feature extraction layer, feature extraction on the intermediate feature of the another timing feature extraction layer to obtain a unit feature output by the another timing feature extraction layer;
wherein a frame rate of the unit feature output by the timing feature extraction layer is the same as a frame rate of the intermediate feature of the timing feature extraction layer.

5. The method according to claim 3, wherein performing the feature fusion on the at least one unit feature through the voice activity detection model to obtain the time-frequency domain feature comprises:
performing frame rate adjustment on a unit feature of a first frame rate through the voice activity detection model, and fusing the unit feature subjected to the frame rate adjustment with a unit feature of a second frame rate, wherein the first frame rate is less than the second frame rate, and the unit feature subjected to the frame rate adjustment has the second frame rate; and
fusing unit features of various frame rates to obtain a result as the time-frequency domain feature.

6. The method according to claim 3, wherein different timing feature extraction layers have different widths.

7. The method according to claim 1, wherein extracting the frequency domain feature of the first audio signal comprises:
performing framing and frequency domain transformation on the first audio signal to obtain at least one frame of frequency domain signal; and
performing amplitude feature extraction on each of the at least one frame of frequency domain signal to obtain the frequency domain feature of the first audio signal.

8. The method according to claim 7, wherein performing the amplitude feature extraction on the each of the at least one frame of frequency domain signal to obtain the frequency domain feature of the first audio signal comprises:
performing the amplitude feature extraction on the each of the at least one frame of frequency domain signal to obtain an alternative amplitude feature; and
performing data compression on the alternative amplitude feature to obtain the frequency domain feature of the first audio signal.

9. The method according to claim 1, further comprising:
acquiring a second audio signal, and extracting a frequency domain feature of the second audio signal, wherein the second audio signal is taken as an interference reference signal of the first audio signal; and
inputting the frequency domain feature of the second audio signal into the voice activity detection model;
wherein obtaining the voice presence detection result output by the voice activity detection model comprises:
performing feature fusion on the frequency domain feature of the first audio signal and the frequency domain feature of the second audio signal through the voice activity detection model, processing a fused frequency domain feature, and obtaining the voice presence detection result output by the voice activity detection model.

10. A voice activity detection apparatus, comprising: at least one processor; and
a memory communicatively connected to the at least one processor;
wherein the memory stores instructions executable by the at least one processor to cause the at least one processor to perform steps in the following modules:
an audio signal processing module configured to acquire a first audio signal, and extract a frequency domain feature of the first audio signal; and
a signal voice recognition module configured to input the frequency domain feature of the first audio signal into a voice activity detection model, and obtain a voice presence detection result output by the voice activity detection model, wherein the voice activity detection model is configured to detect whether voice is present in the first audio signal.

11. The apparatus according to claim 10, wherein the signal voice recognition module comprises:
a time-frequency domain feature extraction unit configured to perform feature extraction on the frequency domain feature through a timing feature extraction layer in the voice activity detection model to obtain a time-frequency domain feature, wherein the timing feature extraction layer is configured to perform time domain feature extraction on the frequency domain feature; and
a time-frequency domain feature classification unit configured to process the time-frequency domain feature through a classification layer in the voice activity detection model to obtain and output the voice presence detection result.

12. The apparatus according to claim 11, wherein the voice activity detection model comprises at least one timing feature extraction layer; and
wherein the time-frequency domain feature extraction unit comprises:
a feature frame rate adjustment subunit configured to perform frame rate adjustment on the frequency domain feature through the at least one timing feature extraction layer in the voice activity detection model to obtain an intermediate feature of at least one frame rate, and perform feature extraction on the intermediate feature to obtain at least one unit feature corresponding to the at least one frame rate; and
a feature fusion subunit configured to perform feature fusion on the at least one unit feature through the voice activity detection model to obtain the time-frequency domain feature.

13. The apparatus according to claim 12, wherein the voice activity detection model comprises at least two serially connected timing feature extraction layers, a first timing feature extraction layer among the at least two timing feature extraction layers comprises a timing feature extraction model, and another timing feature extraction layer except the first timing feature extraction layer comprises a timing feature extraction model and a frame skipping layer; and
wherein the feature frame rate adjustment subunit is further configured to:
take the frequency domain feature as an intermediate feature of the first timing feature extraction layer;
perform feature extraction on the intermediate feature of the first timing feature extraction layer through the first timing feature extraction layer to obtain a unit feature output by the first timing feature extraction layer;
perform frame skipping processing on a unit feature output by a former serially connected timing feature extraction layer through the another timing feature extraction layer to obtain an intermediate feature of the another timing feature extraction layer; and
perform feature extraction on the intermediate feature of the another timing feature extraction layer through the another timing feature extraction layer to obtain a unit feature output by the another timing feature extraction layer;
wherein a frame rate of the unit feature output by the timing feature extraction layer is the same as a frame rate of the intermediate feature of the timing feature extraction layer.

14. The apparatus according to claim 12, wherein the feature fusion subunit is further configured to:
perform frame rate adjustment on a unit feature of a first frame rate through the voice activity detection model, and fuse the unit feature subjected to the frame rate adjustment with a unit feature of a second frame rate, wherein the first frame rate is less than the second frame rate, and the unit feature subjected to the frame rate adjustment has the second frame rate; and
fuse unit features of various frame rates to obtain a result as the time-frequency domain feature.

15. The apparatus according to claim 12, wherein different timing feature extraction layers have different widths.

16. The apparatus according to claim 10, wherein the audio signal processing module comprises:
a signal spectral analysis unit configured to perform framing and frequency domain transformation on the first audio signal to obtain at least one frame of frequency domain signal; and
an amplitude feature extraction unit configured to perform amplitude feature extraction on each of the at least one frame of frequency domain signal to obtain the frequency domain feature of the first audio signal.

17. The apparatus according to claim 16, wherein the amplitude feature extraction unit comprises:
an alternative amplitude feature determination subunit configured to perform the amplitude feature extraction on the each of the at least one frame of frequency domain signal to obtain an alternative amplitude feature; and
an amplitude feature compression subunit configured to perform data compression on the alternative amplitude feature to obtain the frequency domain feature of the first audio signal.

18. The apparatus according to claim 10, further comprising:
a second audio signal acquisition module configured to acquire a second audio signal, and extract a frequency domain feature of the second audio signal, wherein the second audio signal is taken as an interference reference signal of the first audio signal; and
a second audio signal processing module configured to input the frequency domain feature of the second audio signal into the voice activity detection model;
wherein the signal voice recognition module comprises:
a frequency domain feature fusion unit configured to perform feature fusion on the frequency domain feature of the first audio signal and the frequency domain feature of the second audio signal through the voice activity detection model, process a fused frequency domain feature, and obtain the voice presence detection result output by the voice activity detection model.

19. A non-transitory computer-readable storage medium storing computer instructions for causing a computer to execute the following steps:
acquiring a first audio signal, and extracting a frequency domain feature of the first audio signal; and
inputting the frequency domain feature of the first audio signal into a voice activity detection model, and obtaining a voice presence detection result output by the voice activity detection model, wherein the voice activity detection model is configured to detect whether voice is present in the first audio signal.
